(19) United States
(12) Patent Application Publication
(10) Pub. No.: US 2026/0214137 A1
(43) Pub. Date: Jul. 23, 2026

(54) ADAPTIVE OFFLOADING IN AN INTERNET OF THINGS ECOSYSTEM

(71) Applicant: Cypress Semiconductor Corporation, San Jose, CA (US)

(72) Inventors: Avik Santra, Irvine, CA (US); Rakesh Taori, McKinney, TX (US)

(73) Assignee: Cypress Semiconductor Corporation, San Jose, CA (US)

(21) Appl. No.: 19/028,095

(22) Filed: Jan. 17, 2025

(51) Int. Cl. H04L 67/10; H04L 41/16; H04L 67/12

(52) U.S. Cl. CPC H04L 67/10; H04L 41/16; H04L 67/12

(57) ABSTRACT

Data is collected by a first device of an internet of things (IoT) ecosystem for an operation of the first device. A current device status of the first device is obtained. A processing recommendation based on the data and current device status is received from a trained reinforcement learning agent. A second device of the IoT ecosystem is determined to execute the operation of the first device based on the processing recommendation. The operation of the first device is caused to be executed on the second device.

### TECHNICAL FIELD

Aspects and implementations of the present disclosure relate to adaptive offloading in an Internet of Things (IoT) ecosystem.

### BACKGROUND

The Internet of Things (IoT) ecosystem refers to a vast network of interconnected devices, such as IoT devices, that communicate over the internet, enabling automation, real-time data collection, and remote control in applications ranging from smart homes to industrial systems. While advancements in wireless communication, data processing, and hardware miniaturization have driven IoT's growth, several challenges remain, including energy efficiency, as many devices operate in remote or resource-constrained environments and require continuous power. This invention addresses this issue by offering a solution that optimizes energy use, allowing IoT devices to function longer and more efficiently without the need for frequent power sources or battery replacements.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example IoT ecosystem, in accordance with implementations of the present disclosure.

FIG. 2A illustrates an example centralized approach for adaptive offloading in the IoT ecosystem of FIG. 1, in accordance with implementations of the present disclosure.

FIG. 2B illustrates an example decentralized approach for adaptive offloading in the IoT ecosystem of FIG. 1, in accordance with implementations of the present disclosure.

FIG. 3A depicts a flow diagram of an example method for training a reinforcement learning agent for adaptive offloading, in accordance with implementations of the present disclosure.

FIG. 3B depicts a flow diagram of an example method for adaptive offloading, in accordance with implementations of the present disclosure.

FIG. 4 is a block diagram illustrating an exemplary computer system, in accordance with implementations of the present disclosure.

### DETAILED DESCRIPTION

Aspects of the present disclosure relate to adaptive offloading in an internet of things ecosystem. The IoT ecosystem is a network of interconnected IoT devices which have become integral to both consumer and industrial applications, performing tasks such as data capture, object recognition, and self-monitoring. A critical challenge in IoT device design is balancing functionality with battery life, as many of these devices operate on limited battery power. The core technical problem lies in optimizing task execution while maximizing battery efficiency. IoT devices must perform complex operations that demand significant processing power, yet they need to conserve energy for extended operation without frequent recharging. This creates a fundamental tension between device functionality and longevity.

Traditional approaches to this challenge fall into two categories: simpler on-device processing and cloud offloading. Simpler on-device processing prioritizes battery conservation by performing basic tasks locally. While it extends battery life, it often compromises device functionality. For example, a smart doorbell might only conduct basic motion detection instead of advanced person identification. Cloud offloading, on the other hand, maintains full functionality by sending data to cloud servers for processing. However, it rapidly depletes battery life due to constant data transmission, especially over cellular networks. It also introduces latency and raises privacy concerns related to data transmission and storage on external servers.

Both simpler processing and cloud offloading methods have significant limitations, primarily due to their lack of adaptability in dynamic environments. These approaches rely on static, pre-defined rules for task execution, which can lead to inefficiencies such as wasting resources on unnecessary local operations or transmitting data when local processing would suffice. Furthermore, they often result in suboptimal performance trade-offs, where devices either sacrifice advanced features to conserve battery life or rapidly deplete their power to maintain full functionality. Consequently, there is a clear need for advanced task management techniques that can dynamically balance processing requirements with energy conservation.

Aspects and embodiments of the present disclosure address these and other limitations of the existing technology by including a dynamic task offloading component, in local devices and/or edge devices of an IoT ecosystem, that provides a recommendation of which device of the IoT ecosystem to perform operations of the local device.

The IoT ecosystem typically includes local devices, edge devices, and clouds. Local devices, such as smart sensors, wearables, and home appliances, interact directly with the physical environment, collecting data or performing specific tasks. Edge devices, such as smart gateways, sit between local devices and the cloud, forming an edge network that process data closer to its source, reducing latency and bandwidth usage. Clouds are remote servers providing vast storage and processing capabilities for complex analytics, long-term data storage, and coordination across multiple edge networks.

The dynamic task offloading component includes a model and a reinforcement learning (RL) agent. The model, such as Markov decision process (MDP) model, is a mathematical framework used to describe decision-making in an environment where outcomes are partly random and partly under the control of a decision maker (e.g., the local device). The model can be used to describe an environment of a local device of the IoT ecosystem through states (e.g., device status), possible actions (e.g., local processing, edge offloading, or cloud offloading), transition probabilities between states (e.g., impact on device status based on action), and rewards for actions taken (e.g., positive or negative). The RL agent starting with an initial version of a policy (e.g., a decision-making strategy) interacts with a training environment of the local device to refine the policy until a balance between maintaining battery level and completion of the operation of the local device is achieved. The training environment is generated via an emulator or test bed using the model. In particular, the RL agent observes the state of the training environment, selects an action based on its policy (balancing exploration of new actions with exploitation of known good actions), executes the action, receives a reward and observes the new state of the training environment, then refines the policy.

During operations of the local device, the local device collects data related to an operation of the local device and device status of the local device. Data related to the operation of the local device can be, for example, video data (e.g., data) for object detection or person identification (e.g., operation). The device status of the local device may include, for example, a battery level of the local device and connectivity of the local device. The local device provides the data and device status to the dynamic task offloading component (specifically, the RL agent with the refined policy). The RL agent, using the data and device status, determines a processing recommendation or recommended action (e.g., local processing, edge offloading, or cloud offloading). Responsive to the recommended action, the local device causes the operation of the local device to be executed according to the recommended action (or processing recommendation). For example, if the recommended action (or processing recommendation) is edge offloading, the local device transmits the data to the edge device to execute the operation. After execution of the operation, the local device may determine an execution status of the operation and obtain a subsequent device status after execution of the operation. The local device provides, to the dynamic task offloading component, the execution status and device status which is used by the dynamic task offloading component to further refine its policy.

Aspects of the present disclosure overcome these deficiencies by improving the dynamic balancing of processing requirements and energy conservation, and enhancing the efficiency of decision-making in IoT devices.

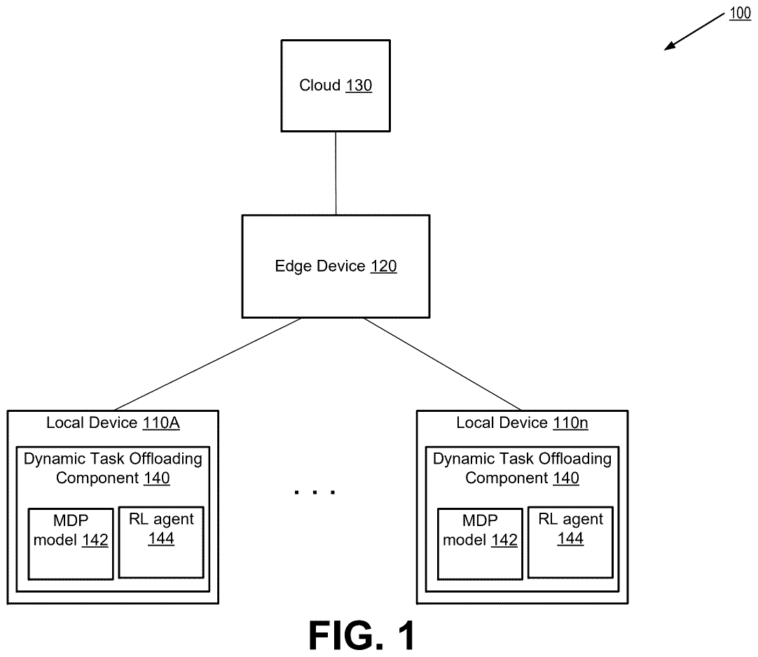

FIG. 1 illustrates an IoT ecosystem 100, in accordance with implementations of the present disclosure. The IoT ecosystem 100 includes local device(s) 110A-n, edge device 120, and a cloud 130. The local device(s) 110A-n may include sensor(s), actuator(s), a processing unit, a memory device, a power supply (e.g., a battery), communication modules, and necessary interfaces, all working together to collect data, process information, and interact with its environment. The edge device 120 may include a processing unit, a memory device, advanced networking and security capabilities, and the ability to run complex applications, serving as an intermediary between local device(s) 110A-n and the cloud 130 to process data and manage communications. The cloud 130 may include a distributed collection of computing, storage, and networking resources designed to process, store, and analyze large volumes of data from the local device(s) 110A-n while providing flexible, on-demand services.

The dynamic task offloading component 140 includes a MDP model 142 and a reinforcement learning (RL) agent 144. As previously described, the MDP model 142 includes state(s), action(s), state transition(s), and reward(s). Each state represents a unique configuration or condition of the environment. The state(s) can include, for example, low battery level, medium battery level, high battery level, low network connectivity, medium network connectivity, or high network connectivity. Battery level refers to an amount of power present in the power supply (e.g., battery). Network connectivity refers to a strength of the connection between devices (e.g., local device(s) 110A-n, edge device 120, and cloud 130) in the IoT ecosystem 100.

Each action represents an available choice in each state, potentially changing the state of the environment and yielding reward(s). The action(s) can include, for example, local processing, edge offloading, or cloud offloading. Local processing refers to a local device processing the data of the local device for an operation. Edge offloading refers to an edge device processing the data of the local device for an operation. Cloud offloading refers to a cloud processing the data of the local device for an operation.

State transition(s) refers to how the environment moves from one state to another as a result of an action taken. The state transition(s) are typically probabilistic, reflecting the uncertainty in real-world environments and is often denoted as P(s′|s,a) which specifies the probability of moving to state s'given that action a was taken in state s. Reward(s) refers to numerical values assigned to state transition(s) or state-action pairs, representing immediate feedback and guidance towards desirable behaviors. Reward(s) often denoted as R(s,a,s′) specifies these values, with the goal typically being to maximize cumulative reward over time, often considering a discount factor for future rewards. The reward(s) may be a positive value, for example, which indicates increased battery life (e.g., minimal impact to battery level) and a successful operation, or a negative value, for example, which indicates decreased battery life (e.g., significant impact to battery level) and a failed operation.

State transition probabilities and reward values are typically set based on known scenarios and domain knowledge. State transition probabilities are derived from understanding how actions likely affect the environment, while reward values are assigned to reflect desired outcomes and their relative importance. The state transition probabilities and reward values start of as initial estimates, based on historical insight and/or data of the environment, and may be refined through simulation, empirical observation, or iterative testing to better align with the goal and actual behavior of the environment.

For example, numerous examples of how varying complexity of an operation (e.g., low, medium, or high) may impact varying battery levels (e.g., low medium, or high) based on a specific action (e.g., local processing, edge offloading, or cloud offloading). For example, a low complexity operation with high battery level may negligibly impact the battery level with local processing but noticeably impact the battery level with edge or cloud offloading. Thus, the state transition probabilities and reward values may be high (and/or positive) for local processing but low (and/or negative) for edge or cloud offloading. In another example, a high complexity operation with high battery level may significantly impact the battery level with local processing but minimally impact the battery level with edge or cloud offloading. Thus, the state transition probabilities and reward values may be high (and/or positive) for edge or cloud offloading but low (and/or negative) for local processing. In some embodiments, other factors and/or scenarios, such as conditions for the actions (e.g., trigger conditions, switch conditions, etc.), network performance, capabilities of the edge device and/or cloud, on-demand requirements, operation curbing, etc., may be used in setting state transition probabilities and reward values.

The RL agent 144 refers artificial intelligence that learns to make optimal decisions by interacting with an environment (modeled by MDP), receiving feedback in the form of rewards, and iteratively improving its decision-making policy to maximize long-term rewards. Initially, a reinforcement learning algorithm (e.g., Q-learning or state-action-reward-state-action (SARSA)) is used to define the core operational principles of how the RL agent 144 learns and makes decisions. The RL agent 144 is then initialized with a default policy that maps states to actions. The RL agent 144 is then connected to the MDP model 142, allowing it to observe states from the state space of the MDP model 142, take actions from the defined action space, and receive rewards based on the reward function of the MDP model 142. Key parameters like learning rate and discount factor may be predefined to govern how the RL agent 144 learns from its interactions with the MDP model 142. Thus, the RL agent 144 can begin learning an optimal policy through repeated interactions with the MDP model 142.

The RL agent 144 interacts with the MDP model 142 to learn optimal decision-making strategies (e.g., the policy). During training, the RL agent 144 explores different actions in a simulated environment to learn, through trial and error, the best action for each state to maximize long-term battery level with successful task completion. Training may be initiated and performed prior to deployment of the local device in an actual environment, or initiated and performed after deployment of the local device in the actual environment via a user interface (or application) of the local device.

More specifically, the RL agent 144 observes a current state of a simulated environment (or real-world testbed). The simulated environment (or real-world testbed) is created by implementing the components of the MDP model 142 —states, actions, transitions, and rewards —to accurately represent the intended scenario for RL agent 144 training and testing. The RL agent 144 selects an action based on its current policy. The current policy, during the first iteration, is an initial predefined policy based on historical data of the local device, such as battery consumption, network conditions, task complexity, and successful/failed analysis outcomes. The policy, essentially a function mapping states to actions, uses state(s) to determine the best action to take.

The RL agent 144 receives feedback from the simulated environment in the form of a new state and a reward. The RL agent 144 updates its policy or internal knowledge (e.g., Q-values) based on this interaction. This cycle is repeated for many iterations, allowing the RL agent 144 to learn and improve its policy within the simulated environment. The RL agent 144 adjusts its exploration-exploitation balance over time, gradually decreasing the exploration rate in favor of exploitation.

The performance of the RL agent 144 is continuously assessed in terms of battery level and task completion after each iteration or set of iterations. If necessary, hyperparameters or the reward structure are adjusted to improve performance. The iterative process continues until the performance of the RL agent 144 reaches a satisfactory level. Once the performance of the RL agent 144 reaches the satisfactory level, the trained RL agent 144 including its learned policy is deployed to the local device.

Once the trained RL agent 144 is deployed on the local device (or the edge device), the local device collects data for an operation (e.g., object/person detection in response to detecting motion). Once the data is collected, the local device obtains a current device status, such as battery level and network conditions (i.e., relevant information associated with the different states of the MDP model). The RL agent 144 references (or consults) the learned policy to select the appropriate action (e.g., local processing, edge offloading, or cloud offloading) for that state. This could be done deterministically (choosing the highest-valued action) or probabilistically (choosing actions with probabilities proportional to their estimated values). The selected action is then executed in the environment, leading to a new state and potentially a reward. The reward is determined by first assessing the new state of the environment and the actual outcome (e.g., battery consumption or execution status) resulting from the action of the RL agent 144. Then, based on this assessment, a reward is assigned according to predefined criteria within the MDP model, reflecting how well the outcome aligns with the goal of the system, such as maximizing battery levels or successful task completion in resource-constrained IoT devices. The MDP model (e.g., state transitions) may be updated using the actual outcome. In some embodiments, once the MDP model is updated, the RL agent 144 is retrained. In other embodiments, the RL agent 144 may be periodically retrained. For example, the RL agent 144 to be retrained every predetermined period of time (e.g., daily, weekly, monthly) or in response to receiving a request to retrain. The RL agent 144 may be retrained periodically as a result of periodic (e.g., daily, weekly, monthly) update of the MDP model.

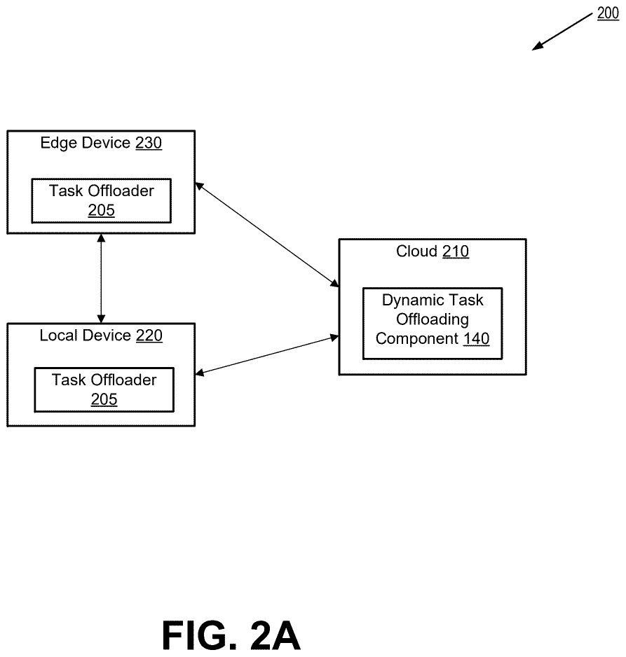

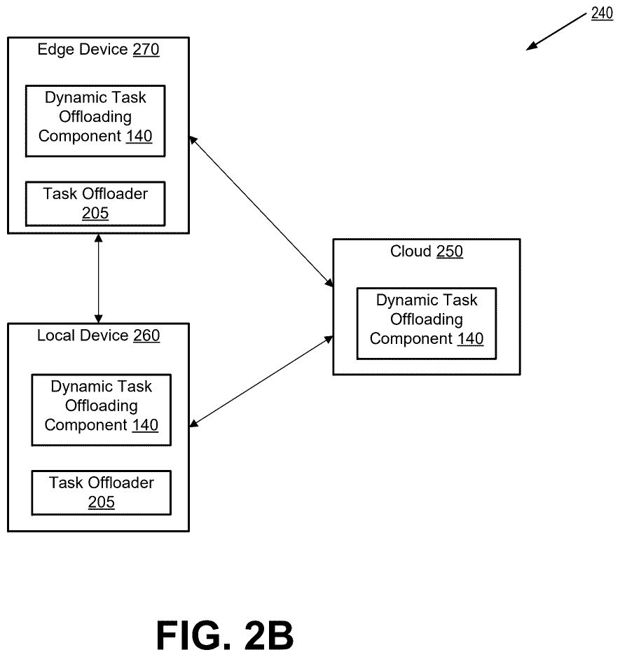

FIG. 2A illustrates an example centralized approach for adaptive offloading, in accordance with implementations of the present disclosure. In the centralized approach, the IoT ecosystem 200 includes a cloud 210, a local device 220, and an edge device 230. The cloud 210 includes the dynamic task offloading component 140. The cloud 210 receives, from the local device 220, operation complexity of the operation and its device status. The cloud 210 receives, from the edge device 230, its device status. The cloud 210 determines network connectivity of the IoT ecosystem 200. The dynamic task offloading component 140, using the device status of local device 220, the operation complexity, the device status of edge device 230, and the network connectivity of the IOT ecosystem 200, selects a recommended action (e.g., local processing, edge offloading, or cloud offloading). The recommended action is then provided to a task offloader 205 of the local device 220 and/or a task offloader 205 of the edge device 230 to be executed. The task offloader 205 offloads the operation according to the recommended action. For example, the task offloader 205 of the local device 220 may indicate that the operation should be offloaded to the edge device 230 and offloads the operation to the edge device 230. In another example, the task offloader 205 of the edge device 230 may indicate that the operation should be offloaded to the edge device 230 or cloud 210, and cause local device 220 to offloads the operation to the edge device 230 or cloud 210.

FIG. 2B illustrates an example decentralized approach for adaptive offloading, in accordance with implementations of the present disclosure. In the decentralized approach, In the decentralized approach, the IoT ecosystem 240 include a cloud 250, a local device 260, and an edge device 270. The cloud 250, the local device 260, and the edge device 270 include a dynamic task offloading component 140. The dynamic task offloading component 140 of the local device 260 receives the device status of the local device 260, operation complexity of the operation of the local device 260, and network connectivity. The dynamic task offloading component 140 of the local device 260 selects a recommended action of the local device 260 (e.g., local processing, edge offloading, or cloud offloading).

Similarly, the dynamic task offloading component 140 of the edge device 270 receives the device status of the edge device 270, operation complexity of the operation of the edge device 270, and network connectivity. The dynamic task offloading component 140 of the edge device 270 selects a recommended action of the edge device 270 (e.g., local processing, edge offloading, or cloud offloading).

The recommended action of the local device 260 and the recommended action of the edge device 270 is provided to the dynamic task offloading component 140 of the cloud 250. The cloud 250 selects, from the recommended action of the local device 260 and the recommended action of the edge device 270, a recommended action for the IoT ecosystem 240. The recommended action is then provided to a task offloader 205 of the local device 260 and/or a task offloader 205 of the edge device 270 to be executed. The task offloader 205 offloads the operation according to the recommended action.

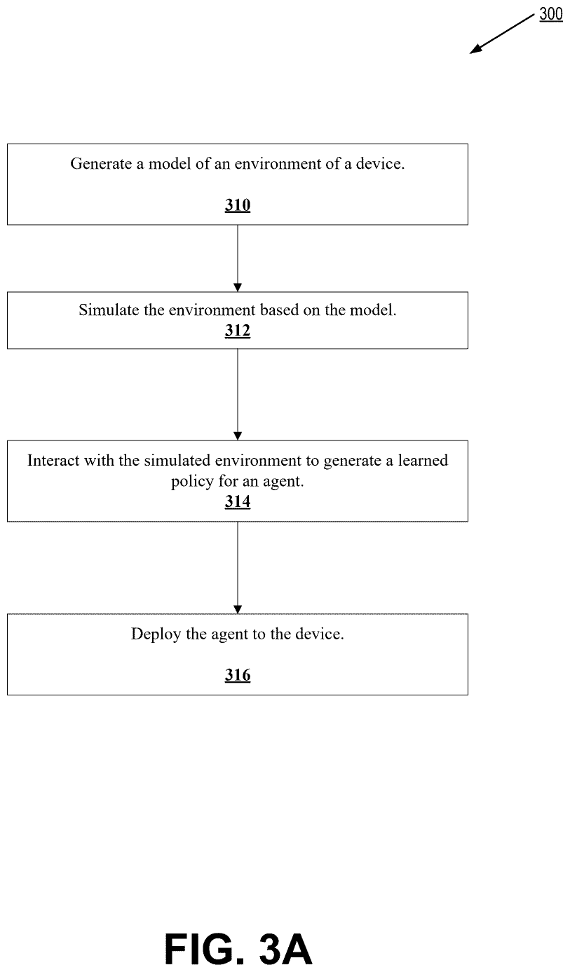

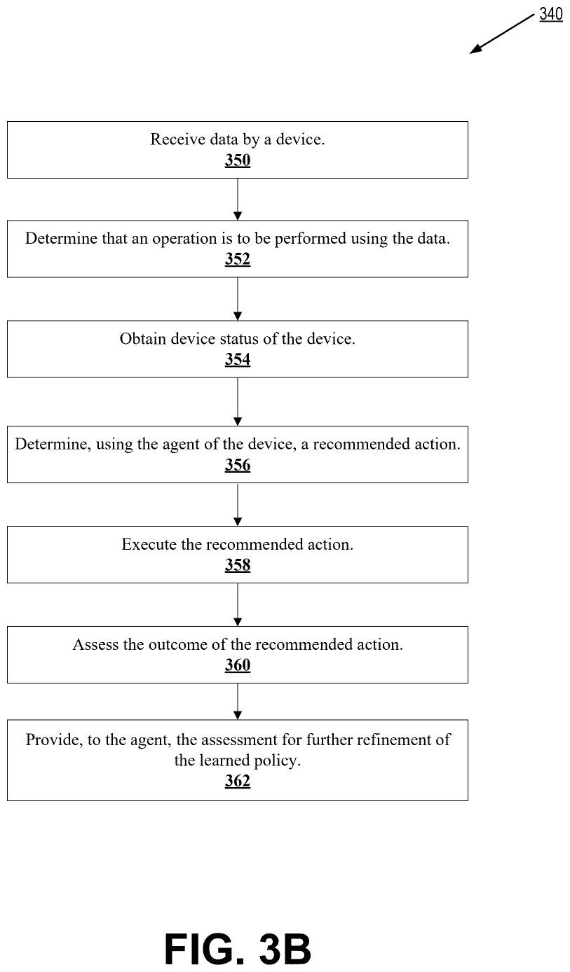

FIG. 3A is a flow diagram of a method 300 for training a reinforcement learning agent for adaptive offloading, in accordance with implementations of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the dynamic task offloading component 140.

At operation 310, the processing logic generates a model of an environment of a device (e.g., a first device or local device). As previously described, the model includes state(s), action(s), state transition(s), and reward(s) which represents a unique configuration or condition of the environment. At operation 312, the processing logic simulates the environment based on the model. As previously described, the simulated environment (or real-world testbed) is created by implementing the components of the model—states, actions, transitions, and rewards—to accurately represent the intended scenario for an agent's training and testing.

At operation 314, the processing logic interacts with the simulated environment to generate a learned policy for an agent. As previously described, the processing logic causes the agent to interact with the simulated environment to learn optimal decision-making strategies (e.g., a policy). In particular, the agent selects an action based on its current policy, receives feedback from the simulated environment in the form of a new state and a reward, and updates its policy or internal knowledge (e.g., Q-values) based on this interaction. This cycle is repeated for many iterations, allowing the agent to learn and improve its policy within the simulated environment.

At operation 316, the processing logic deploys the agent to the device. As previously described, the agent is deployed on a local device (first device) or an edge device (second device) in which data is collected for an operation (e.g., object/person detection in response to detecting motion). The agent references (or consults) the learned policy to select the appropriate action (e.g., local processing, edge offloading, or cloud offloading) for a state associated with the collected data.

FIG. 3B is a flow diagram of a method 340 for adaptive offloading, in accordance with implementations of the present disclosure. The method 340 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 340 is performed by the dynamic task offloading component 140.

At operation 350, the processing logic receives data by a device (e.g., a first device or local device). As previously described, the data may be data for an operation (e.g., object/person detection in response to detecting motion). At operation 352, the processing logic determines that an operation is to be performed using the data. At operation 354, the processing logic obtains device status of the device. As previously described, the device status can include battery level and network conditions (i.e., a state of the device)

At operation 356, the processing logic determines, using the agent of the device, a recommended action. As previously described, the agent determines the recommendation action (e.g., local processing, edge offloading, or cloud offloading) using the data and device status. In particular, the processing logic, using the learned policy of the agent, selects the appropriate action for a state associated with the data. At operation 358, the processing logic executes the recommended action. As previously described, executing the recommended action includes either performing the operation on the local device (e.g., first device) or transferring the data (or offloading) to the edge device (e.g., a second device) or the cloud.

At operation 360, the processing logic assesses the outcome of the recommended action. As previously described, responsive to execution of the recommended action, the processing logic receives execution status of the operation and device status of the local device after execution of the operation. The processing logic determines a reward based on the execution status and the device status. At operation 362, the processing logic provides, to the agent, the assessment for further refinement of the learned policy. As previously described, the processing logic updates the model based on the reward and retrains the agent.

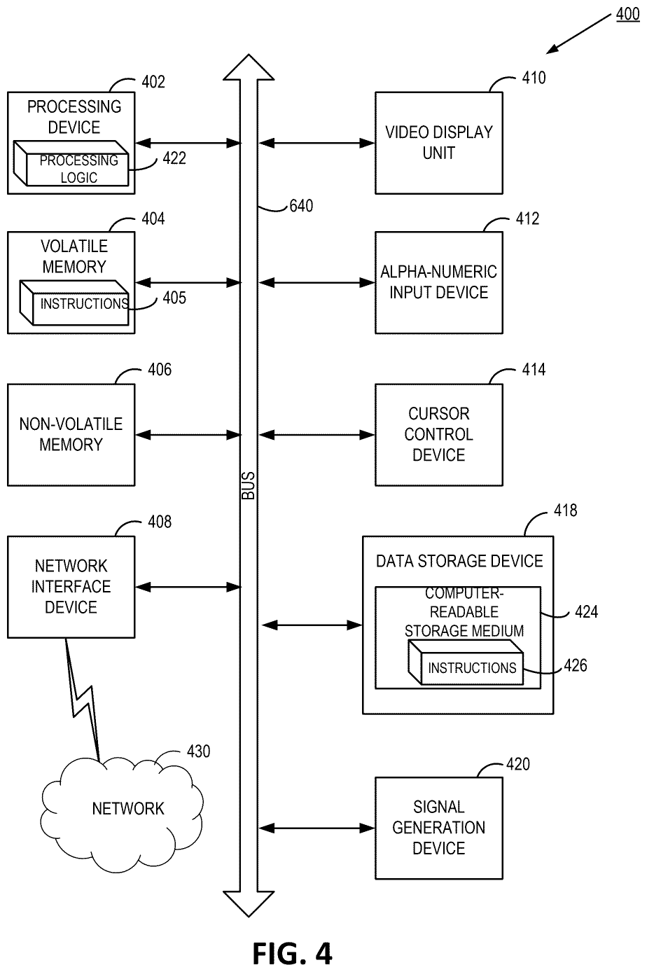

FIG. 4 is a block diagram illustrating an exemplary computer system 400, in accordance with implementations of the present disclosure. Computer system 400 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processing device (processor) 402, a main memory 404 (e.g., read-only memory (ROM), flash memory, dynamic random access memory (DRAM) such as synchronous DRAM (SDRAM), double data rate (DDR SDRAM), or DRAM (RDRAM), etc.), a static memory 406 (e.g., flash memory, static random access memory (SRAM), etc.), and a data storage device 418, which communicate with each other via a bus 440.

Processor (processing device) 402 represents one or more general-purpose processing devices such as a microprocessor, central processing unit, or the like. More particularly, the processor 402 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 402 can also be one or more special-purpose processing devices such as an application specific integrated circuit (ASIC), a field programmable gate array (FPGA), a digital signal processor (DSP), network processor, or the like. The processor 402 can include processing logic 422 used to perform the operations discussed herein. The processor 402 is configured to execute instructions 405 for performing the operations discussed herein.

The computer system 400 can further include a network interface device 408. The computer system 400 also can include a video display unit 410 (e.g., a liquid crystal display (LCD) or a cathode ray tube (CRT)), an input device 412 (e.g., a keyboard, and alphanumeric keyboard, a motion sensing input device, touch screen), a cursor control device 414 (e.g., a mouse), and a signal generation device 420 (e.g., a speaker).

The data storage device 418 can include a non-transitory machine-readable storage medium 424 (also non-transitory computer-readable storage medium) on which is stored one or more sets of instructions 426 embodying any one or more of the methodologies or functions described herein. The instructions can also reside, completely or at least partially, within the main memory 404 and/or within the processor 402 during execution thereof by the computer system 400, the main memory 404 and the processor 402 also constituting machine-readable storage media. The instructions can further be transmitted or received over a network 430 via the network interface device 408.

While the computer-readable storage medium 424 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding, or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “comprises,” “comprising,” “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “block,” “layer,” “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution, and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a non-transitory computer-readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include a collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
collecting, by a first device of an internet of things (IoT) ecosystem, data for an operation of the first device;
obtaining a current device status of the first device;
receiving, from a trained reinforcement learning (RL) agent, a processing recommendation based on the data and current device status;
determining, based on the processing recommendation, a second device of the IoT ecosystem to execute the operation of the first device; and
causing the operation of the first device to be executed on at least one of the first device or the second device.

2. The method of claim 1, wherein the current device status of the first device includes at least one of: a battery level of the first device or a network connectivity of the first device.

3. The method of claim 1, wherein the first device is a local device of the IoT ecosystem.

4. The method of claim 1, wherein the second device is one of: an edge device or a cloud of the IoT ecosystem.

5. The method of claim 1, further comprising:
responsive to execution of the operation of the first device, determining an execution status of the operation;
obtaining a subsequent device status of the first device after execution of the operation;
providing, to the trained RL agent, the subsequent device status and execution status; and
causing the trained RL agent to be retrained based on the subsequent device status and execution status.

6. The method of claim 1, wherein causing the operation of the first device to be executed on the second device comprises:
responsive to determining that the second device is different from the first device, transmitting the data for the operation of the first device to the second device; and
causing the second device to execute the operations of the first device using the data.

7. The method of claim 1, wherein the trained reinforcement learning agent is included in at least one of: the first device or the second device.

8. A non-transitory computer-readable medium comprising instructions that, responsive to execution by a processing device, cause the processing device to perform operations comprising:
collecting, by a first device of an internet of things (IoT) ecosystem, data for an operation of the first device;
obtaining a current device status of the first device;
receiving, from a trained reinforcement learning agent, a processing recommendation based on the data and current device status;
determining, based on the processing recommendation, a second device of the IoT ecosystem to execute the operation of the first device; and
causing the operation of the first device to be executed on at least one of the first device or the second device.

9. The non-transitory computer-readable medium of claim 8, wherein the current device status of the first device includes at least one of: a battery level of the first device or a network connectivity of the first device.

10. The non-transitory computer-readable medium of claim 8, wherein the first device is a local device of the IoT ecosystem.

11. The non-transitory computer-readable medium of claim 8, wherein the second device is one of: an edge device or a cloud of the IoT ecosystem.

12. The non-transitory computer-readable medium of claim 8, wherein the processing device is to perform operations further comprising:
responsive to the execution of the operation of the first device, determining an execution status of the operation;
obtaining a subsequent device status of the first device after execution of the operation;
providing, to the trained reinforcement learning agent, the subsequent device status and execution status; and
causing the trained reinforcement learning agent to be retrained based on the subsequent device status and execution status.

13. The non-transitory computer-readable medium of claim 8, wherein causing the operation of the first device to be executed on the second device comprises:
responsive to determining that the second device is different from the first device, transmitting the data for the operation of the first device to the second device; and
causing the second device to execute the operations of the first device using the data.

14. The non-transitory computer-readable medium of claim 8, wherein the trained reinforcement learning agent is included in at least one of: the first device or the second device.

15. An Internet of Things (IoT) ecosystem comprising:
a local device;
an edge device, wherein the edge device is coupled to the local device; and
a cloud, wherein the cloud is coupled to the edge device, and wherein the local device is to perform operations comprising:
collecting, by a first device of an internet of things (IoT) ecosystem, data for an operation of the first device;
obtaining a current device status of the first device;
receiving, from a trained reinforcement learning agent, a processing recommendation based on the data and current device status;
determining, based on the processing recommendation, a second device of the IoT ecosystem to execute the operation of the first device; and
causing the operation of the first device to be executed on at least one of the first device or the second device.

16. The IoT ecosystem of claim 15, wherein the current device status of the first device includes at least one of: a battery level of the first device or a network connectivity of the first device.

17. The IoT ecosystem of claim 15, wherein the first device is a local device of the IoT ecosystem, and wherein the second device is one of: an edge device or a cloud of the IoT ecosystem.

18. The IoT ecosystem of claim 15, wherein the trained reinforcement learning agent is included in at least one of: the first device or the second device.

19. The IoT ecosystem of claim 15, wherein the local device is to perform operations further comprising:
responsive to the execution of the operation of the first device, determining an execution status of the operation;
obtaining a subsequent device status of the first device after execution of the operation;
providing, to the trained reinforcement learning agent, the subsequent device status and execution status; and
causing the trained reinforcement learning agent to be retrained based on the subsequent device status and execution status.

20. The IoT ecosystem of claim 15, wherein causing the operation of the first device to be executed on the second device comprises:
responsive to determining that the second device is different from the first device, transmitting the data for the operation of the first device to the second device; and
causing the second device to execute the operations of the first device using the data.
